(19) United States
(12) Patent Application Publication
(10) Pub. No.: US 2016/0182985 A1
(43) Pub. Date: Jun. 23, 2016

(54) TRIM-PIECE SPEAKER SYSTEM

(71) Applicant: Vyacheslav Konstantynov, Saskatoon (CA)

(72) Inventor: Vyacheslav Konstantynov, Saskatoon (CA)

(21) Appl. No.: 14/580,909

(22) Filed: Dec. 23, 2014

(51) Int. Cl. H04R 1/02; H04R 27/00

(52) U.S. Cl. CPC H04R 1/028; H04R 27/00; H04R 2201/021; H04R 2227/005; H04R 2420/07

(57) ABSTRACT

A trim-piece speaker system is disclosed. The trim-piece speaker system includes a ceiling rose having a primary outer surface on a first side. The ceiling rose defines a cavity on second side opposite to the first side. The trim-piece speaker system also includes at least one speaker assembly mounted in the cavity of the ceiling rose.

### BACKGROUND

1. Field

The present disclosure relates to trim pieces for static structures such as molding for the interior of shelters, houses, or buildings.

2. Description of Related Prior Art

U.S. Pat. No. 7,535,341 discloses a COMBINATION SPEAKER/LIGHT FIXTURE. The sound producing elements is an arrangement of speakers having a low frequency transducer and one or more high frequency transducers oriented directed to emit sound in a particular direction. The fixture may further include digital signal processing to modify the sound to account for obstructions in near or around the fixture. The fixture may include a feedback system that allow the fixture to self modify its frequency response. The signal to the fixture is provided by wired or wireless interface. The surface of the sound transducer can be reflective in nature to provide focusing or diffusion of the light from the lighting elements. The lighting elements are incandescent, fluorescent or low voltage LED type that may include adjustment for lighting intensity or color.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A trim-piece speaker system is disclosed. The trim-piece speaker system includes a ceiling rose having a primary outer surface on a first side. The ceiling rose defines a cavity on second side opposite to the first side. The trim-piece speaker system also includes at least one speaker assembly mounted in the cavity of the ceiling rose.

### BRIEF DESCRIPTION OF THE DRAWINGS

The detailed description set forth below references the following drawings:

FIG. 1 is a top view of a trim-piece speaker system incorporating an exemplary embodiment of the present disclosure;

FIG. 2 is a bottom view of the trim-piece speaker system shown in FIG. 1;

FIG. 3 is a side, exploded view of ceiling-mounted light assembly incorporating the trim-piece speaker system shown in FIG. 1;

FIG. 4 is a functional block diagram of an exemplary embodiment of a controller assembly for an exemplary embodiment of the present disclosure;

FIG. 5 is a partial cross-section taken through section lines 5-5 in FIG. 1;

FIG. 6 is a partial cross-section analogous to FIG. 5; and

FIG. 7 is a top view of a trim-piece speaker system incorporating another exemplary embodiment of the present disclosure.

### DETAILED DESCRIPTION

A plurality of different embodiments of the present disclosure is shown in the Figures of the application. Similar features are shown in the various embodiments of the present disclosure. Similar features have been numbered with a common reference numeral and have been differentiated by an alphabetic suffix. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The present disclosure, as demonstrated by the exemplary embodiments described below, can provide an elegant, clean, powerfully-enriched speaker system that is easy to use. Embodiments can be inexpensive, simple to install, and very user friendly. A user need not carry a portable computing device having music from one room to another. The user can be hands-free when speaking on the phone and can enjoy music through an embodiment of the present disclosure.

Many houses still don't have built-in sound systems. One reason for this is because it is expensive, in terms of material and/or labor. One or more embodiments of the present disclosure can be utilized to define a whole-house sound system.

An embodiment of the present disclosure can be controlled by more than one device. For example, one occupant of the home may want to listen to a trim-piece speaker system in a first room. At the same time, another occupant can use another trim-piece speaker system in a second room. In another example, a user can pass through different rooms of a house while trim-piece speakers in different rooms engage when the user enters each room. Embodiments can also operate such that multiple trim-piece speaker systems in multiple rooms concurrently play the same music. A trim-piece speaker system can include memory for storing music, ads, playlists, and audio books.

One or more embodiments can automatically pair with a computing device such as a mobile device, tablet, or laptop. One or more embodiments can bring easy access to media to any room in a home and makes speakers/docks, clunky stereos, surround sound systems and many any other audio gadgets obsolete. One or more embodiments can be hardwired in-between the ceiling and a light fixture, where the light fixture itself is not necessary if the room already has another source of light. The trim-piece speaker system can then have a box cover. The trim-piece system can interact with mobile devices via Bluetooth and software applications on smart phones, tablets or any other sort of device where applications can be accessed and downloaded. The trim-piece speaker system can run on an interior battery. One or more embodiments can be on the light circuit so that switching the light on allowed power to flow to the system. In such an embodiment, the system could charge automatically. For multiple systems in more than one room, different speakers can be on at the same time. They can also be isolated at the users' discretion and can also be paired with multiple devices for multiple uses. One or more embodiments can include a power management that can control charging of the battery and the supply of AC or DC power.

Another advantage of one or more embodiments of the present disclosure is that the speaker can be flush with the visible surface of the trim-piece. Further, for a trim-piece having embossing, the speaker can be recessed from the embossing. As a result, the trim-piece speaker system has the appearance of a standard trim-piece and enhances the aesthetics of the room. The speaker can be fully or substantially concealed to maintain the character of the room.

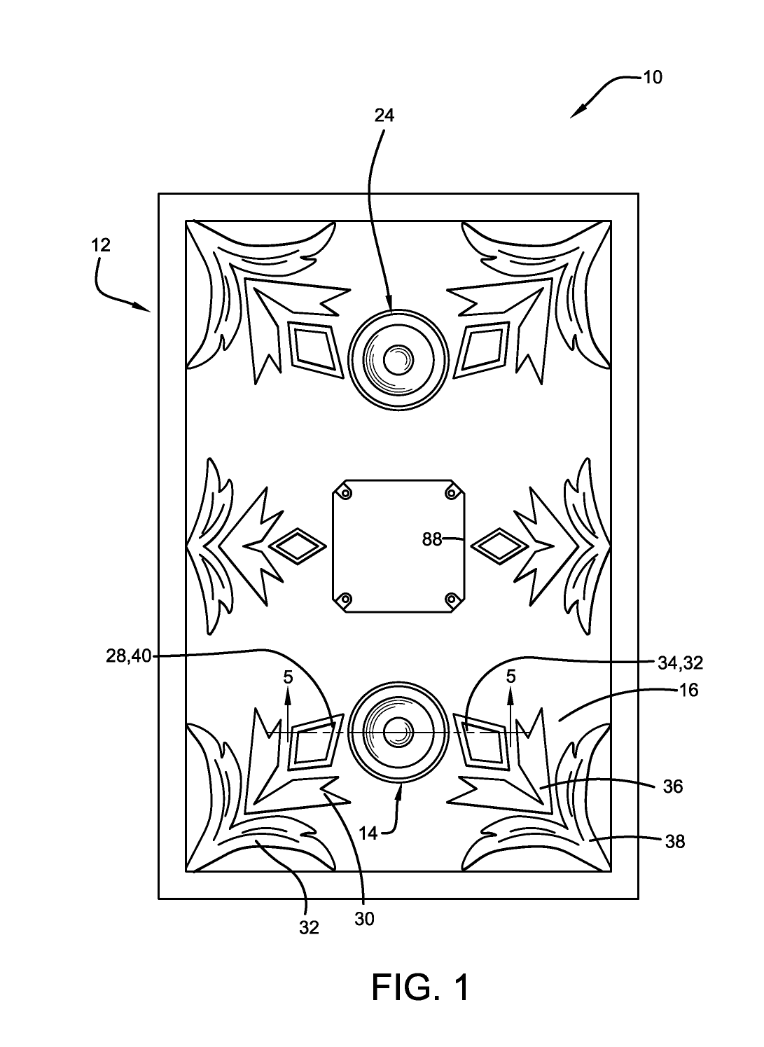

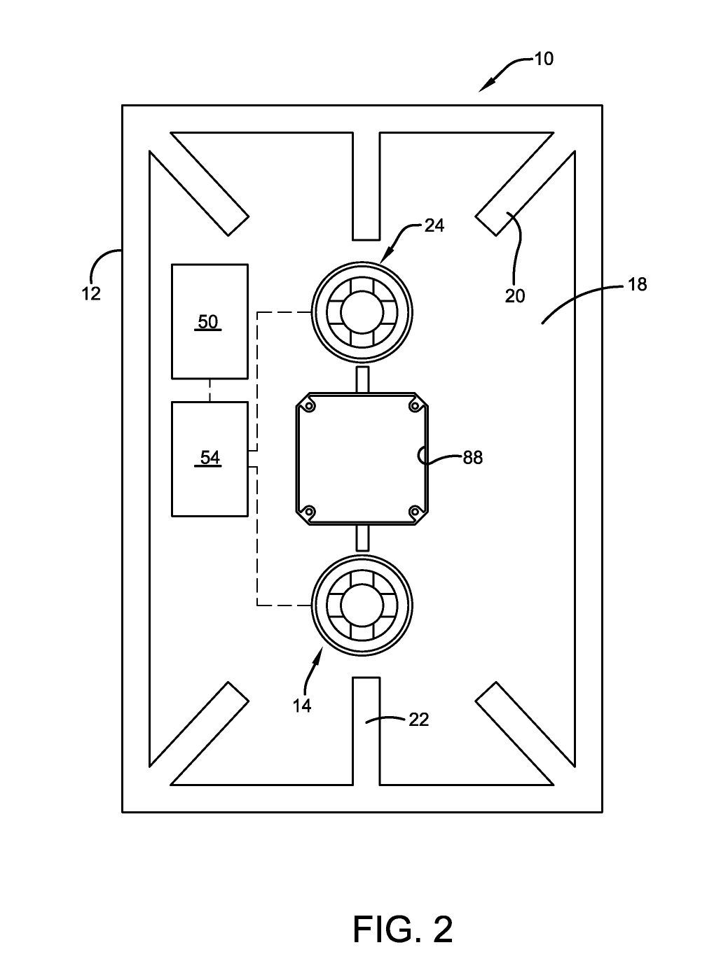

As shown in FIGS. 1-3, a trim-piece speaker system 10 can include a ceiling rose 12 and at least one speaker assembly 14. Generally, a ceiling rose is a molding mountable to a ceiling. The exemplary ceiling rose 12 can be mounted in the center of the ceiling. Alternatively, a plurality of ceiling roses 12 can be mounted on a single ceiling. A chandelier or light fixture can be suspended below the ceiling rose 12; however the ceiling roses 12 can be mounted without a lighting fixture. The ceiling rose 12 can be any shape. The ceiling rose 12 can include a primary outer surface 16 on a first side (shown in FIG. 1). The ceiling rose 12 can define a cavity 18 on second side (shown in FIG. 2) opposite of the first side. The ceiling rose 12 can be made from any material. The exemplary ceiling rose 12 can be plastic and include strengthening ribs, such as referenced at 20 and 22.

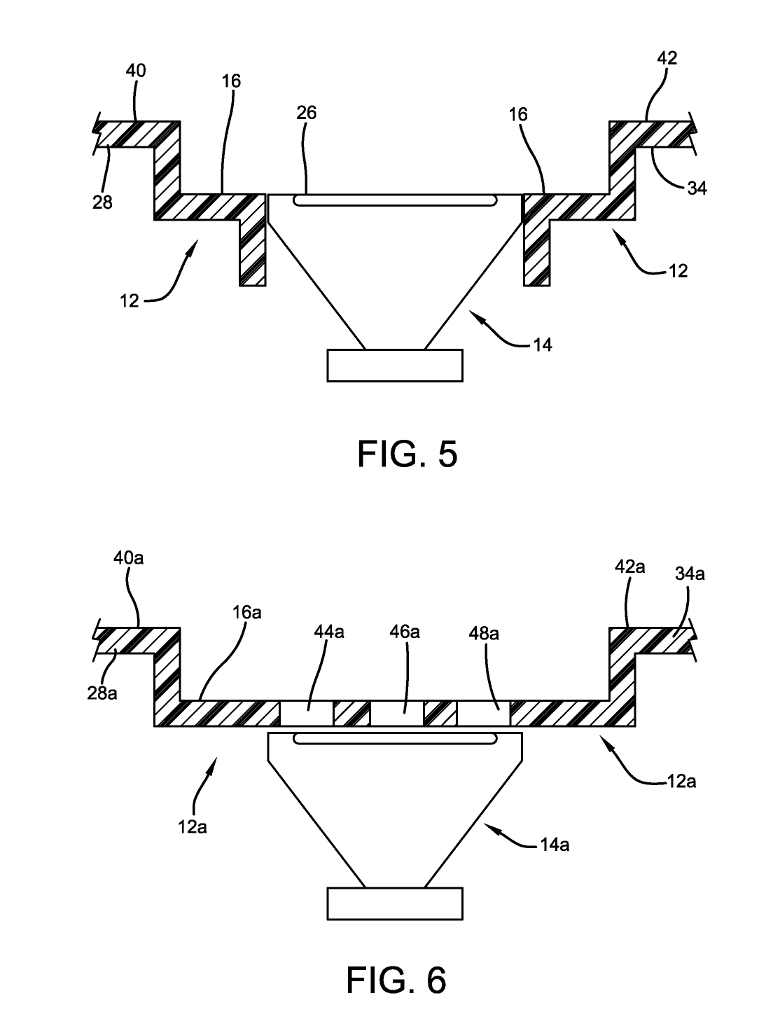

The exemplary embodiment includes first and second speaker assemblies 14 and 24. Each of the speaker assemblies 14, 24 can be mounted in the cavity 18 of the ceiling rose 12. As shown in FIG. 5, an outer face 26 of the speaker assemblies 14, 24 can be substantially flush with the primary outer surface 16.

The ceiling rose 12 can include elements such as embossing or recesses relative to the primary flat surface 16. The exemplary ceiling rose 12 includes a plurality of embossings projecting away from the primary outer surface 16. As shown in FIG. 1, a first plurality of embossings 28, 30, 32 form a first floral pattern. A second plurality of embossings 34, 36, 38 form a second floral pattern. Each of the embossings 28-38 defines a secondary outer surface spaced from the primary outer surface 16. For example, the embossing 28 defines a secondary outer surface 40 spaced from the primary outer surface 16 and the embossing 34 defines a secondary outer surface 42 spaced from the primary outer surface 16. The speaker assemblies 14, 24 can be recessed from the secondary outer surfaces. FIG. 5 illustrates the outer face 26 recessed from the secondary outer surfaces 40, 42. Also, the speaker assembly 14 is positioned between the first and second embossing 28, 34.

FIG. 6 illustrates an alternative embodiment of the present disclosure. A ceiling rose 12a can include apertures 44a, 46a, and 48a. A speaker assembly 14a can be positioned adjacent to the apertures 44a, 46a, 48a. The speaker assembly 14a can also be recessed from the primary outer surface 16a and the secondary outer surfaces 40a, 42a of embossings 28a, 34a.

As best shown in FIG. 2, the exemplary trim-piece speaker system 10 can also include at least one battery 50 disposed in the cavity 18. The battery 50 can be rechargeable. The battery 50 can supply electrical power to emit sound from the speakers 14, 24.

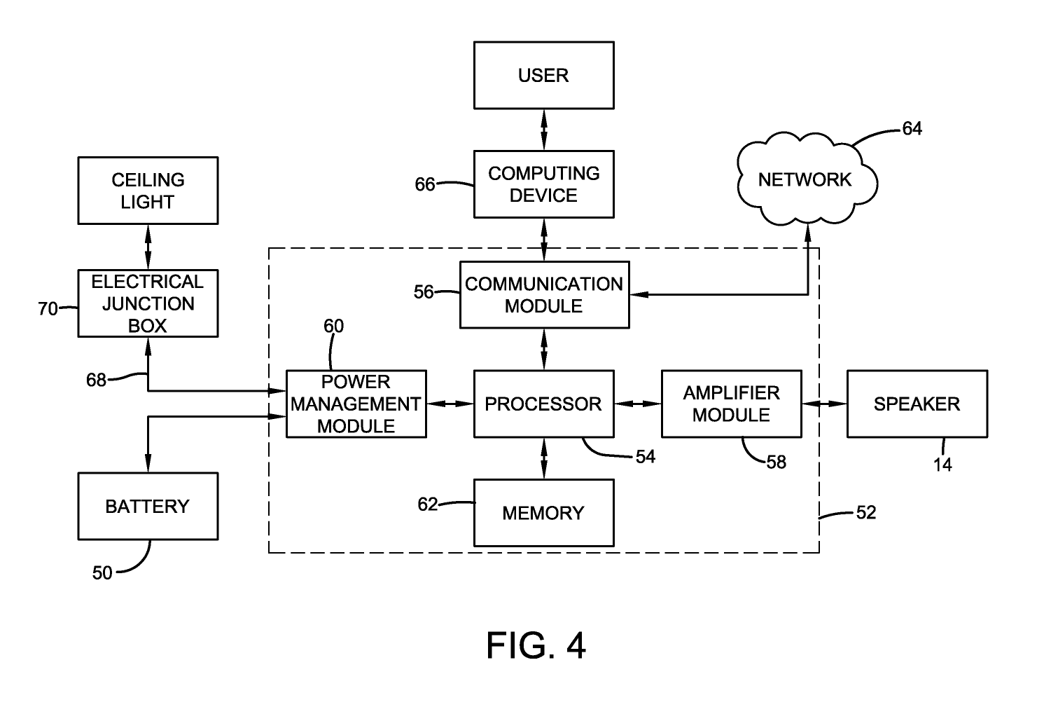

The exemplary trim-piece speaker system 10 can also include a controller assembly 52. The controller assembly 52 can receive commands and control the output of sound from the speakers 14, 24. FIG. 4 is a functional block diagram of the exemplary controller assembly 52. The exemplary controller assembly 52 can include a processor 54, a communication module 56, an amplifier module 58, a power management module 60, and memory 62.

The processor 54 can be operable to receive signals generated by the other components of the controller assembly 52. The processor 54 can also be operable to control the other components of the controller assembly 52. The processor 54 can also be operable to process signals received from a user. While one processor 54 is illustrated, it should be appreciated that the term “processor” can include two or more processors that operate in an individual or distributed manner. The processor 54 can be configured to perform general functions including, but not limited to, controlling communication via the communication module 56 and controlling read/write operations at the memory 62. The processor 54 can also be configured to perform specific functions relating to at least a portion of the present disclosure including, but not limited to, loading/executing sound files.

The communication module 56 can be configured to transmit signals generated by the other components of the controller assembly 52. The processor 54 can direct signals generated by components of the controller assembly 52 to a user's computing device 66 through the communication module 56. Examples of possible computing devices 66 include desktop computers, laptop computers, tablet computers, and mobile phones.

The communication module 56 can be an electrical communication element within the processor 54 in one or more embodiments of the present disclosure. The communication module 56 can also be configured to receive signals and direct signals that are received to the processor 54 for further processing. The communication module 56 can be operable to receive transmissions from a network 64 and then communicate the transmissions to the processor 54.

The communication module 56 can communicate over a Wifi network, allowing the control assembly 52 to exchange data wirelessly (using radio waves) over a computer network, including high-speed Internet connections. The communication module 56 can also apply Bluetooth® standards or communications protocol for exchanging data over short distances by using short-wavelength radio transmissions, and thus creating personal area network (PAN). The transmitter 48 and receiver 50 can also apply 3G or 4G, which is defined by the International Mobile Telecommunications-2000 (IMT-2000) specifications promulgated by the International Telecommunication Union.

The amplifier module 58 can be electrical communication with the at least one speaker 14. The processor 54 can direct signals corresponding to a sound file through the amplifier module 58 to the speaker 14. The controller 54 can also control the amplification applied by the amplifier module 58 to control the volume of sound coming from the speaker 14. The controller 54 can also control the power directed to the amplifier module 58 from the battery 50.

The power management module 60 can be configured to monitor a charge level of the battery 50. The power management module 60 can also be configured to regulate charging of the battery 50. The power management module 60 can include at least one lead 68 configured to electrically communicate with a junction box 70. The at least one lead 68 can be maintained behind the primary outer surface 16. The power management module 60 can also provide power to the processor 54 and provide AC/DC conversion capability.

The memory module 62 can be utilized to store sound files and/or apps executable by the processor 54. The memory module 62 can be any combination of one or more computer-writeable or computer-readable media may be utilized in various embodiments of the disclosure. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

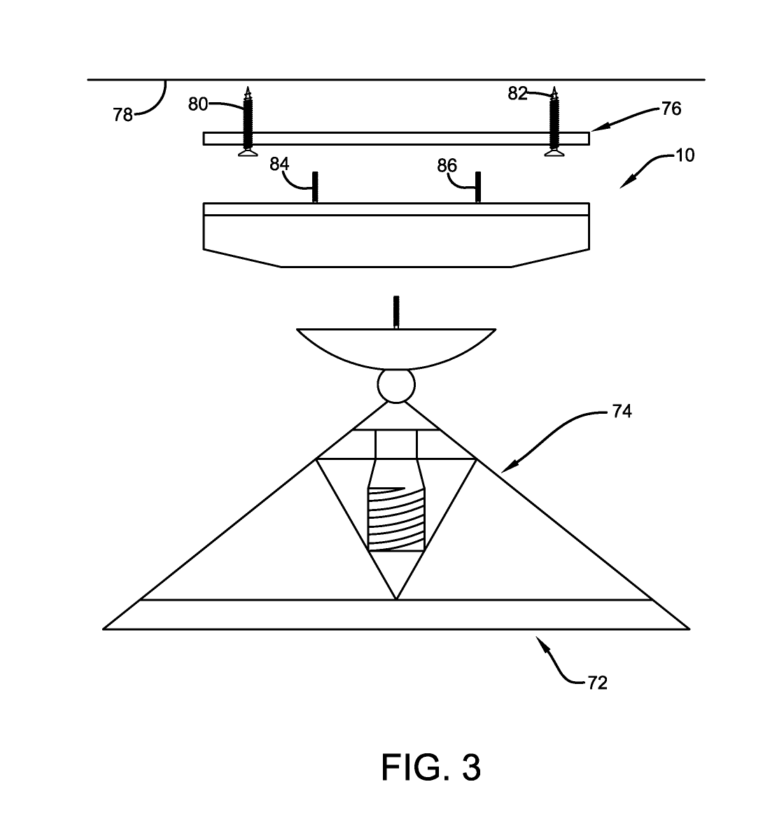

FIG. 3 is a side, exploded view of ceiling-mounted light assembly 72 incorporating the trim-piece speaker system 10 shown in FIGS. 1 and 2. The ceiling-mounted light assembly 72 also includes a ceiling light 74 and mounting bracket 76. The mounting bracket 76 can provide a wider base for enhanced support of the trim-piece speaker system 10. The mounting bracket 76 can be mounted to a ceiling 78 with fasteners, such as fasteners 80, 82. The mounting bracket 76 can include threaded apertures (not shown) for receiving fasteners mounted in the trim-piece speaker system 10, such as fasteners 84, 86. The trim-piece speaker system 10 can include a center aperture 88 for receiving the ceiling light 74 and for allowing the ceiling light 74 to be mechanically and/or electrically connected to the junction box 70.

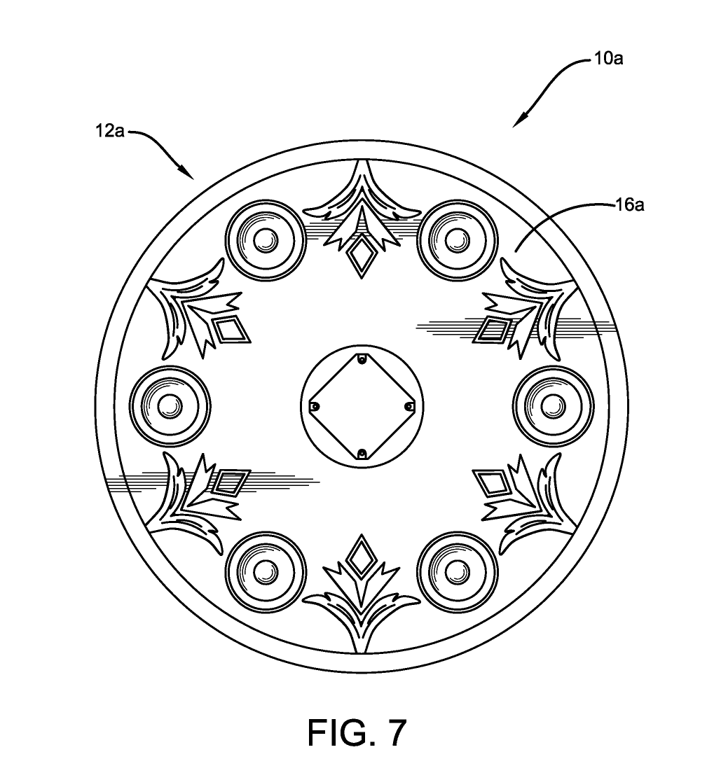

FIG. 7 is a top view of a trim-piece speaker system 10a according to another exemplary embodiment of the present disclosure. The trim-piece speaker system 10a can include a ceiling rose 12a having a primary outer surface 16a on a first side. The ceiling rose 16a can also define a cavity (not visible in FIG. 7) on second side opposite to the first side. The trim-piece speaker system 10a also includes at least one speaker assembly 14a mounted in the cavity of the ceiling rose 12a. In FIG. 7, the ceiling rose 12a includes a plurality of embossings each projecting away from the primary outer surface 16a. Each of a plurality of speakers is each positioned between adjacent pairs of the plurality of embossings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. Further, the “present disclosure” as that term is used in this document is what is claimed in the claims of this document. The right to claim elements and/or sub-combinations that are disclosed herein as other present disclosures in other patent documents is hereby unconditionally reserved.

What is claimed is:

1. A trim-piece speaker system comprising:
a ceiling rose having a primary outer surface on a first side and defining a cavity on second side opposite said first side; and
at least one speaker assembly mounted in said cavity of said ceiling rose.

2. The trim-piece speaker system of claim 1 wherein said at least one speaker assembly further comprises an outer face substantially flush with said primary outer surface.

3. The trim-piece speaker system of claim 1 wherein:
said ceiling rose further comprises at least one embossing projecting away from said primary outer surface and defining a secondary outer surface spaced from said primary outer surface; and
said at least one speaker assembly further comprises an outer face recessed from said secondary outer surface.

4. The trim-piece speaker system of claim 1 wherein:
said ceiling rose further comprises first and second embossings projecting away from said primary outer surface, wherein said at least one speaker assembly is positioned between said first and second embossings.

5. The trim-piece speaker system of claim 1 wherein:
said ceiling rose further comprises at least one aperture, wherein said at least one speaker assembly is positioned adjacent to at least one aperture and recessed from said primary outer surface.

6. The trim-piece speaker system of claim 1 further comprising:
at least one battery disposed in said cavity.

7. The trim-piece speaker system of claim 6 further comprising:
a controller assembly having a power management module configured to monitor a charge level of said at least one battery.

8. The trim-piece speaker system of claim 7 wherein said power management module is further configured to regulate charging of said at least one battery.

9. The trim-piece speaker system of claim 1 further comprising:
a controller assembly having an amplifier module in electrical communication with said at least one speaker.

10. The trim-piece speaker system of claim 1 further comprising:
a controller assembly having a communication module configured to receive control signals.

11. The trim-piece speaker system of claim 10 wherein said communication module is further defined as configured to receive control signals with Bluetooth communication protocol.

12. The trim-piece speaker system of claim 10 wherein said communication module is further defined as configured to receive control signals over Wifi.

13. The trim-piece speaker system of claim 10 wherein said controller assembly further comprises computer-readable and computer-writeable memory.

14. A trim-piece speaker system comprising:
a ceiling rose having a primary outer surface on a first side and defining a cavity on second side opposite said first side;
at least one speaker assembly mounted in said cavity of said ceiling rose;
at least one rechargeable battery disposed in said cavity; and
a controller assembly disposed in said cavity, having one or more control processors, and configured to direct sound files to said at least one speaker assembly and to receive power from said at least one rechargeable battery.

15. The trim-piece speaker system of claim 14 wherein:
said ceiling rose further comprises a plurality of embossings each projecting away from said primary outer surface and defining respective secondary outer surfaces spaced from said primary outer surface; and
said at least one speaker assembly further comprises a plurality of speakers each positioned between adjacent pairs of said plurality of embossings.

16. The trim-piece speaker system of claim 15 wherein said controller assembly further comprises:
a power management module including at least one lead configured to electrically communicate with a junction box, said at least one lead maintained behind said primary outer surface.

17. The trim-piece speaker system of claim 16 wherein said power management module is further defined as operable control recharging of said at least one rechargeable battery.

18. The trim-piece speaker system of claim 17 wherein said controller assembly further comprises:
a communication module configured to receive control signals and direct control signals to said one or more control processors.

19. The trim-piece speaker system of claim 18 wherein said communication module is further defined as configured to transmit signals received from said one or more control processors.

20. The trim-piece speaker system of claim 19 wherein said controller assembly further comprises:
memory configured for read and write access.
